(19) United States
(12) Patent Application Publication
(10) Pub. No.: US 2010/0088197 A1
(43) Pub. Date: Apr. 8, 2010

(54) SYSTEMS AND METHODS FOR GENERATING REMOTE SYSTEM INVENTORY CAPABLE OF DIFFERENTIAL UPDATE REPORTS

(76) Inventors: Michael Paul DEHAAN, Morrisville, NC (US); Adrian K. Likins, Raleigh, NC (US)

Correspondence Address: MH2 TECHNOLOGY LAW GROUP (Cust. No. w/Red Hat), 1951 KIDWELL DRIVE, SUITE 550, TYSONS CORNER, VA, 22182, US

(21) Appl. No.: 12/244,329

(22) Filed: Oct. 2, 2008

(51) Int. Cl. G06Q 10/00

(52) U.S. Cl. 705/28

(57) ABSTRACT

Embodiments relate to systems and methods for generating a remote system inventory capable of differential update reports. A network management server communicates with a set of hosts, e.g. local servers, each in turn serving a set of client computers or other targets. A systems administrator can interrogate any target and/or host to receive an inventory of the hardware, software, or other resources installed on the subject machine. The resulting inventory report can be stored as a tree, database, or other record based on the host name of the host or target being inventoried. A series of inventory reports generated over time can be stored. The systems administrator can access the inventory data store and generate comparative or differential reports on the inventory of a subject machine captured at different times. Differential updates can be transmitted to an administrator or other user via an RSS or other feed.

### FIELD

The present teachings relate to systems and methods for generating remote system inventories capable of differential update reports, and more particularly to platforms and techniques for remotely requesting inventory updates on target machines, including inventories of installed hardware and software, and recording a series of inventories for generating differential reports on updates.

### BACKGROUND OF RELATED ART

Network management platforms exist which permit a systems administrator or other user to transmit an inventory query to one or more systems in a network. The systems receiving those queries can respond with a list or other structured data that reflects the hardware installation, software installation, or other configuration state of that machine.

In networks equipped with conventional inventory engines, the network management server can receive selected hardware, software, or other inventory from remote machines, but the ability to manipulate inventory records is limited. For example, in conventional inventory platforms the type of data can be limited, so that, for example, commands may only exist to collect hardware inventory or software inventory but not both. Once a response from the target machines is collected, the inventory reports are moreover typically stored as separate data objects, and direct comparison between the inventory snapshots of a given target or set of targets at different times can be difficult or impossible.

It may be desirable to provide methods and systems for remotely generating a system inventory that are capable of capturing and storing running inventory reports over time, and provide a capability to compare any two or more selected inventory reports to generate a report on the differential changes in the target.

### DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an overall system for systems and methods for remotely generating a system inventory that are capable of differential update reports, according to various embodiments;

FIG. 2 illustrates a data schema for a version management tree storing individual inventory reports, according to various embodiments;

FIG. 3 illustrates an exemplary hardware configuration for a network management server that can be used in systems and methods consistent with the present teachings, according to various embodiments; and

FIG. 4 illustrates a flowchart of overall inventory capture, storage and differential report processing, according to various embodiments.

### DESCRIPTION OF EMBODIMENTS

Embodiments of the present teachings relate to systems and methods for generating a remote system inventory capable of differential update reports. More particularly, embodiments related to platforms and techniques for interrogating a remote network host and/or a set of targets served by that host, to generate an inventory of the hardware, software, or other resources present on the subject machine. The inventory request command can be generated by a network management server, or other control point. The network management server can receive a resulting inventory report from the subject machine(s), and store that data to an inventory management store along with any prior inventory reports generated by that machine. The accumulated series of inventory reports can then be analyzed by the network management server to identify changes to the subject machine between any two or more arbitrary time points. The inventory comparison report can identify changes to the subject machine, and for example list the hardware, software, or other updates installed on the machine between inventory points as differential comparisons or updates. A differential comparison or any other data from or based on the series of inventory reports can be transmitted to a systems administrator or other user. In embodiments, the differential comparison or other report can be transmitted via a subscribed data feed, such as an RSS (Really Simple Syndication) feed, Atom™ feed, or other feed, connection or channel. A user can thereby examine compare the full complement of system resources between any two or more points in time, for example, to identify hardware or software changes that preceded a network or other fault. These and other embodiments described herein address the various noted shortcomings in known network management technology, and provide a systems administrator or other user with enhanced analytic tools to profile and diagnose network performance and configurations.

Reference will now be made in detail to exemplary embodiments of the present teachings, which are illustrated in the accompanying drawings. Where possible the same reference numbers will be used throughout the drawings to refer to the same or like parts.

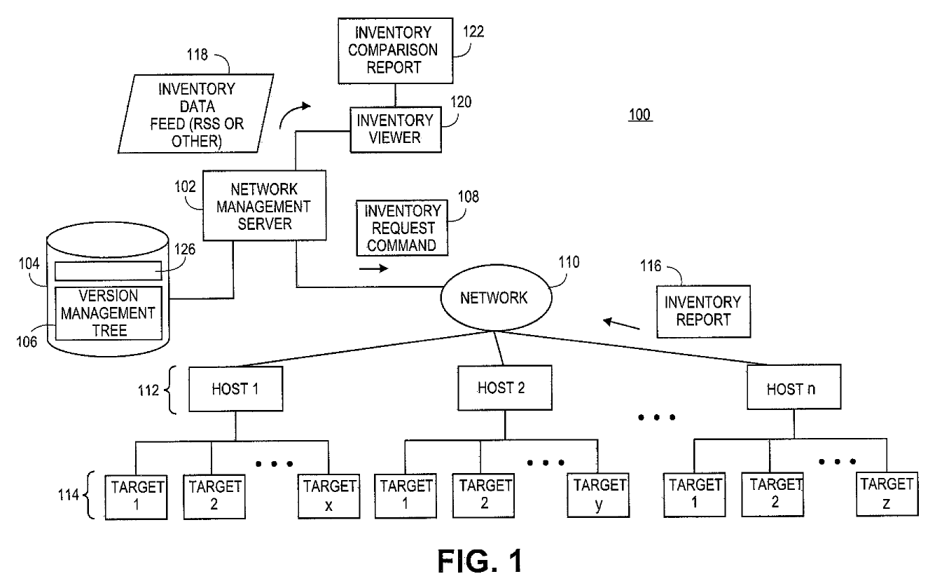

FIG. 1 illustrates an overall system 100 in which systems and methods for generating a remote system inventory capable of differential update reports, according to various embodiments of the present teachings. A network management server 102 can communicate via one or more networks 110 with a set of hosts 112. One or more networks 110 can be or include the Internet, and/or other public or private networks. Set of hosts 112 can be or include a set of servers, each of which serves a set of targets 114 such as personal computers, network-enabled cellular telephones, or other networked devices. Each host machine in the set of hosts 112 can include a set of hardware, software, input/output (I/O) and other resources. Each target machine can similarly include a set of hardware, software, input/output (I/O) and other resources. Network management server 102 can generate an inventory request command 108 to transmit to one or more host in set of hosts 112 via one or more networks 110, to interrogate one or more machines, and produce a requested inventory on that machine.

In embodiments, inventory request command 108 can have a format of an “inventory( )” function, which can request inventory of some or all hardware, software, I/O, and/or other resources on a target machine and return that data to network management server 102. In embodiments, for example, inventory request command 108 can request an inventory identifying resources on the subject system, such as: the current installed packages list for the subject system, the physical devices present in the systems including RAM (random access memory), hard disks, PCI (peripheral connect interface) or other expansion cards, a list of the mounted filesystems, a list of services that are currently enabled, a list of all currently running processes, the contents of specific files such as configuration files, the md5sums of specific files, the filesystem attributes of specific files such as file permissions, modifications times, and SELinux security contexts, and any user-created modules that has an “inventory( )” function, which can be created and distributed without changing the core program, and/or other data. In embodiments, the inventory request command 108 can be transmitted to a machine or machines of interest based on an Internet protocol (IP) address. In embodiments, the inventory request command 108 can be transmitted to set of hosts 112 and/or set of targets 114 via one or more secure channels, such as the secure channel and related resources described in co-pending U.S. application Ser. No. 12/130,424, filed May 30, 2008, entitled “Systems and Methods for Remote Management of Networked Systems Using Secure Modular Platform,” which published as U.S. Patent Application Publication No. ______, assigned or under obligation of assignment to the same entity as this application, and which application is incorporated by reference herein. In embodiments, the inventory request command 108 can request inventory data from one or more hosts in set of hosts 112. In embodiments, the inventory request command 108 can request inventory data from one or more targets in set of targets 114. In embodiments, the inventory request command 108 can request inventory data from mixed hosts and targets at the same time. In embodiments, the inventory request command 108 can be transmitted to a selected target or targets, directly.

The subject machine(s) to which the inventory request command 108 is directed can respond by inspecting their system resources, such as hardware, software, I/O, or other resources, for instance via a call to an operating system installed on the machine, and generate an inventory report 116. The subject machine(s) can transmit the inventory report 116 back to the network management server 102 via network 110, for instance, via the same secure channel(s) between that server and set of hosts 112/set of targets 114. Upon receipt of the inventory report 116, network management server 102 can store the inventory report 116 to inventory store 104 or other data store. Network management server 102 can add the inventory report 116 to any previous reports generated for the subject machine to generate or modify a sequence of inventory reports 126 logging or storing the accumulated inventory data for the subject machine(s).

The management server 102 can examine the sequence of inventory reports 126 to perform a differential comparison or update analysis, to determine the changes and updates to subject machine(s) whose inventory has been recorded. In embodiments, a comparison between any two or more inventory reports 116 can be made to identify the addition, removal, or updates to installed hardware, and/or updates to software versions of applications or operating systems, the installation of new applications or other software, changes to I/O settings or resources, or other changes to the subject machine(s). In embodiments, the comparison between inventory points can be performed based on input from a user, such as a systems administrator or other user operating a local or remote inventory viewer 120 communicating with network management server 102. In embodiments, network management server 102 can generate comparative reports on inventory automatically, for instance, at predetermined intervals or based on predetermined criteria, such as the occurrence of a machine or network fault. Once generated, the set of identified differential updates or other updates or changes can be recorded in an inventory comparison report 122.

In embodiments, the inventory comparison report 122 and/or other data can be transmitted to a systems administrator or other user as an inventory update feed 118 using an automatic data feed service, such as RSS (Really Simple Syndication) or Atom™. In embodiments, the inventory update feed 118 can be configured in “/diff/” format, which in one regard can enhance the convenience of identifying changes or deltas to subject machines and/or software. In embodiments, the inventory update feed 118 can show the differences in configuration or inventory on a host-by-host, target-by-target, and/or module-by-module basis. In embodiments, the inventory update feed 118 can be configured in other formats than “/diff/” format. The user can receive the inventory update feed 118 at a local or remote inventory viewer 120, such as a browser or other application or tool. In embodiments, the inventory update feed 118 can be transmitted at predetermined intervals, and/or can be transmitted at other times, such as based on triggering events such as the installation of new hardware or software, the occurrence of machine or network faults, or based on other parameters. In embodiments, the systems administrator or other user can manipulate inventory viewer 120 to initiate new inventory requests, make or view comparisons of inventory data in sequence of inventory reports 126, and/or take other action.

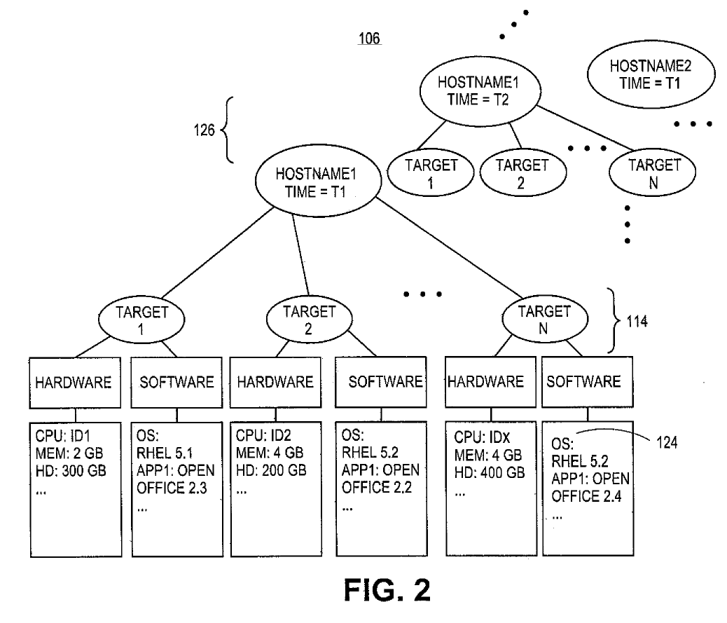

In embodiments, once generated, the sequence of inventory reports 126 can be stored in the form of a structured tree, such as a version management tree 106. FIG. 2 illustrates an exemplary data schema for a version management tree 106 which encapsulates the sequence of inventory reports 126, based on a hierarchical node structure. In version management tree 106, the root or higher-level node(s) can correspond to the hostname of each host in set of hosts 112, while the target machines in set of targets 114 can form lower-level nodes. In each level of version management tree 106, inventory data fields 124 can be stored which record details of the hardware, software, I/O, or other installed resources for the subject device(s) or machine(s). In embodiments, the sequence of inventory reports 126 can also or instead be stored in the form of a database, such as a relational or other database. Other data stores can be used.

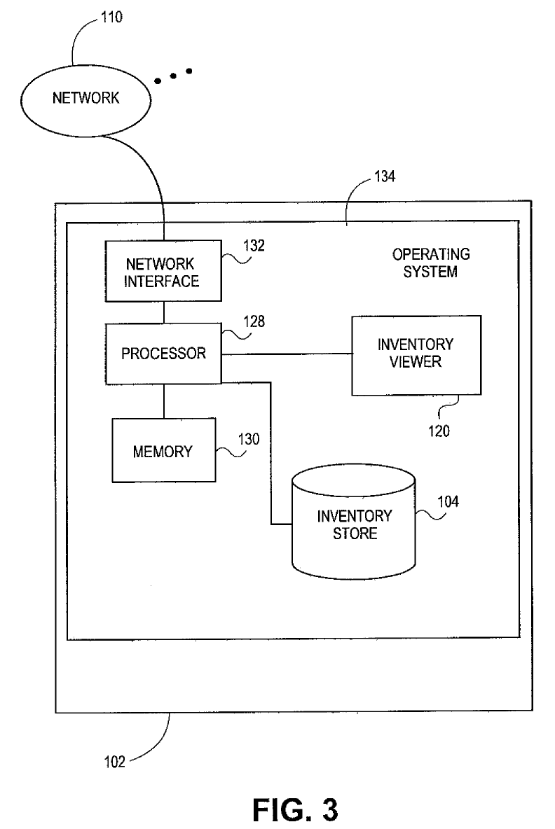

FIG. 3 illustrates an exemplary hardware configuration for network management server 102, consistent with embodiments of the present teachings. In embodiments as shown, network management system 102 can comprise a processor 128 communicating with memory 130, such as electronic random access memory, operating under control of or in conjunction with operating system 134. Operating system 134 can be, for example, a distribution of the Linux™ operating system, the Unix™ operating system, or other open-source or proprietary operating system or platform. Processor 128 also communicates with inventory store 104, such as a tree-based data store, or a database stored on a local hard drive. It may be noted that in embodiments, inventory store 104 can comprises a version control backed filesystem-tree-based data store, using any choice of user-supplied version control platform or system. In embodiments, for example, the Git version control system can be used. In embodiments, other version control systems or protocols can be used, such as the Mercurial, SVN (Subversion), or CVS (Concurrent Versioning System) systems. Processor 128 further communicates with network interface 132, such as an Ethernet or wireless data connection, which in turn communicates with one or more networks 110, such as the Internet or other public or private networks. Processor 128 also communicates with inventory viewer 120, to receive input form a systems administrator or other user to control inventory processing of set of hosts 112 and/or set of targets 114. In embodiments inventory view 120 can comprise a local or remote browser, or other application or tool. Other configurations of network management system 102, associated network connections, and other hardware and software resources are possible.

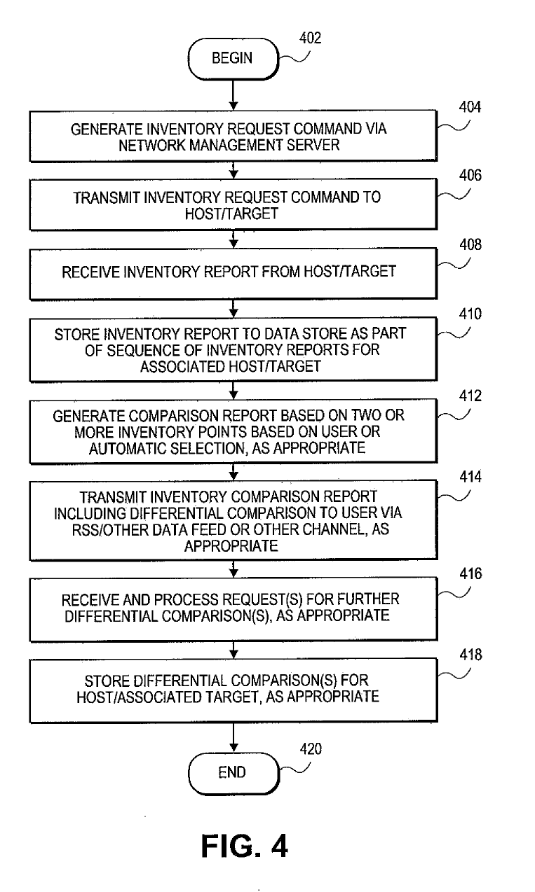

FIG. 4 illustrates a flowchart of overall processing for generating remote system inventories capable of differential update reports, according to various embodiments. In 402, processing can begin. In 404, an inventory request command 108 can be generated in or via network management server 102. In embodiments, the inventory request command 108 can be generated automatically at predetermined intervals, such as once per day, week, month, or other period of time. In embodiments, the inventory request command 108 can be generated via the manual request of a systems administrator or other user. In embodiments, the inventory request command 108 command can be triggered by predetermined events, inputs, or thresholds, such as, for example, the installation of new machines in set of targets 114, the installation of new software in one or more hosts in set of hosts 112, or other conditions. In 406, the inventory request command 108 can be transmitted to one or more hosts in set of hosts 112 and/or one or more targets in set of targets 114.

In 408, an inventory report 116 can be received from the subject host and/or target machine in network management server 102. In 410, the inventory report 116 can be stored to inventory store 104 as part of a sequence of inventory reports 126 for the subject host and/or target. Sequence of inventory reports 126 can comprise a chronological series of inventory reports for a subject host and/or target. In embodiments, the subject inventory report 116 and/or sequence of inventory reports 126 can be stored in the form of a version management tree 106, for instance, stored in a hierarchical format based on the network configuration of the profiled network, with root or higher-level nodes representing the host name of a host machine, and branches representing set of targets 114 associated with that host machine. In embodiments, the subject inventory report 116 and/or sequence of inventory reports 126 can be stored in the form of a database, such as a relational database. In embodiments, the subject inventory report 116 and/or sequence of inventory reports 126 can be stored to a data store in other forms or configurations.

In 412, the network management server 102 can generate an inventory comparison report 122 by performing a comparison between any two or more inventory reports 106 stored in a sequence of inventory reports 126 for a desired host and/or target. For example, the comparison report 122 can comprise a comparison of the set of hardware and/or software resources installed on one or more targets in set of targets 114 hosted by a host within set of hosts 112 at two different times. In embodiments, the comparison report 122 can include a complete listing of all hardware/software inventory at each inspected time. In embodiments, the comparison report 122 can in addition or instead contain a listing or identification of the differences between the inventory reports 106 for the two or more different times, so that a time-series record of updates or changes for that machine is generated.

In 414, in embodiments the comparison report 122 or other report of updates reflected in sequence of inventory reports 126 can be transmitted to a systems administrator or other user via an RSS (Really Simple Syndication) or other subscribed data feed, or via other channels or connections. In embodiments, where an automated data feed is used, the comparison report 122 can be configured to include only differential comparisons or updates, as desired. In embodiments, full reports can in addition or instead be transmitted. In 416, network management server 102 can receive and process any further request(s) from the systems administrator or other user for further comparison report(s) 122 or other data, as appropriate. In embodiments, any further requests for reports or comparisons on states or data in sequence of inventory reports 126 can be received and processed via inventory view 120 communicating with network management server 102, or other interfaces or tools. In 418, any comparison report(s) 122 generated for a subject host and/or target can be stored to inventory store 104, as appropriate. In 420, as understood by persons skilled in the art, processing can repeat, return to a prior processing point, jump to a further processing point, or end.

The foregoing description is illustrative, and variations in configuration and implementation may occur to persons skilled in the art. For example, while embodiments have been described in which a single network management server 102 serves a set of hosts 112 to capture inventory data and generate comparative inventory reports, in embodiments, multiple management servers can cooperate to manage hosts, targets, and inventory processing. In embodiments, similarly, inventory reports and data can be stored to multiple databases or data stores, rather than a single central inventory store 104. Other resources described as singular or integrated can in embodiments be plural or distributed, and resources described as multiple or distributed can in embodiments be combined. The scope of the present teachings is accordingly intended to be limited only by the following claims.

What is claimed is:

1. A method of generating a sequence of inventory reports, comprising:
generating a set of inventory request commands in a management server;
transmitting the set of inventory request commands to at least one networked machine;
receiving a sequence of inventory reports from the at least one networked machine in response to the inventory request commands; and
storing the sequence of inventory reports of the at least one network machine to a data store, wherein the sequence of inventory reports is queryable to generate a differential comparison of at least two inventory reports in the sequence of inventory reports.

2. The method of claim 1, wherein the at least one networked machine comprises at least one of a host and a set of targets.

3. The method of claim 1, wherein the sequence of inventory reports comprises at least one of a set of hardware inventory reports and a set of software inventory reports.

4. The method of claim 1, wherein data store comprises at least one of a tree record and a database record.

5. The method of claim 4, wherein the data store comprises a tree record, and the tree record comprises a root node based on a host name.

6. The method of claim 1, wherein the differential comparison comprises a report of updates on the at least one networked machine that have occurred between the at least two inventory reports.

7. The method of claim 6, wherein the report of updates is transmitted to a user via a subscribed data feed.

8. A system for generating a sequence of inventory reports, comprising:
an interface to at least one networked machine; and
a management server, communicating with the at least one networked machine via the interface, the management server being configured to
generate a set of inventory request commands,
transmit the set of inventory request commands to the at least one networked machine,
receive a sequence of inventory reports from the at least one networked machine in response to the set of inventory request commands,
store the sequence of inventory reports of the at least one network machine to a data store, and
generate a differential comparison of at least two inventory reports in the sequence of inventory reports.

9. The system of claim 8, wherein the at least one networked machine comprises at least one of a host and a set of targets.

10. The system of claim 8, wherein the sequence of inventory reports comprises at least one of a set of hardware inventory reports and a set of software inventory reports.

11. The system of claim 8, wherein the data store comprises at least one of a tree record and a database record.

12. The system of claim 11, wherein the data store comprises a tree record, and the tree record comprises a root node based on a host name.

13. The system of claim 8, wherein the differential comparison comprises a report of updates on the at least one networked machine that have occurred between the at least two inventory reports.

14. The system of claim 13, wherein the management server is further configured to transmit the report of updates to a user via a subscribed data feed.

15. A report of updates to a machine inventory, the report of updates being generating generated by a method comprising:
generating a set of inventory request commands in a management server;
transmitting the set of inventory request commands to at least one networked machine;
receiving a sequence of inventory reports from the at least one networked machine in response to the inventory request commands;
storing the sequence of inventory reports of the at least one network machine to a data store;
generating a differential comparison of at least two inventory reports in the sequence of inventory reports; and
generating the report of updates based on the differential comparison.

16. The report of updates of claim 15, wherein the at least one networked machine comprises at least one of a host and a set of targets.

17. The report of updates of claim 15, wherein the sequence of inventory reports comprises at least one of a set of hardware inventory reports and a set of software inventory reports.

18. The report of updates of claim 15, wherein data store comprises at least one of a tree record and a database record.

19. The report of updates of claim 18, wherein the data store comprises a tree record, and the tree record comprises a root node based on a host name.

20. The report of updates of claim 15, wherein the differential comparison comprises a report of updates on the at least one networked machine that have occurred between the at least two inventory reports.

21. The report of updates of claim 20, wherein the method further comprises transmitting the report of updates to a user via a subscribed data feed.
